(19) United States
(12) Patent Application Publication
(10) Pub. No.: US 2026/0010446 A1
(43) Pub. Date: Jan. 8, 2026

(54) IMPLEMENTING A HETEROGENEOUS STORAGE TIERING REGIME FOR HIGH-PERFORMANCE FAILURE RECOVERY

(71) Applicant: Nutanix, Inc., San Jose, CA (US)

(72) Inventors: Veeral Prabodhchandra Shah, Pune (IN); Prasad Gajanan Joshi, Pune (IN); Anand Mitra, Pune (IN); Prathamesh Vasant Chavan, Aurangabad (IN); Vishal Raj, Pune (IN)

(73) Assignee: Nutanix, Inc., San Jose, CA (US)

(21) Appl. No.: 19/255,592

(22) Filed: Jun. 30, 2025

Related U.S. Application Data
(60) Provisional application No. 63/803,307, filed on May 9, 2025.

(30) Foreign Application Priority Data
Jul. 3, 2024 (IN) 202441050886

(51) Int. Cl. G06F 11/20; G06F 11/16

(52) U.S. Cl. CPC G06F 11/2094; G06F 11/1662; G06F 2201/805

(57) ABSTRACT

Methods, systems, and computer program products for rebuilding data of a cloud-attached computing cluster. In operation, a computing cluster having at least two nodes is configured to host virtualized entities that are configured to access a common storage access address space. The nodes have respective node-local non-volatile storage devices. The node-local non-volatile storage devices are configured into a first storage tier that stores node-local data. Additional cloud-provided storage is attached to the nodes such that the additional cloud-provided storage forms a second storage tier that stores replicas of the node-local data. In the event of a loss of node functionality, node recovery is accomplished by attaching the additional cloud-provided storage to a replacement node and then rebuilding, on the replacement node, rebuilt first storage tier data based on promotion of certain replicas of the node-local data that are stored in the second storage tier of the additional cloud-provided storage.

### RELATED APPLICATIONS

The present application claims the benefit of priority to U.S. Provisional Patent Application Ser. No. 63/803,307 titled “IMPLEMENTING A HETEROGENEOUS STORAGE TIERING REGIME FOR HIGH-PERFORMANCE FAILURE RECOVERY” filed on May 9, 2025, and the present application claims the benefit of priority to India patent application No. 202441050886 titled “USING CLOUD-PROVIDED NETWORK ACCESSIBLE VOLUMES FOR STORAGE TIERING AND QUICK FAILURE RECOVERY” filed on Jul. 3, 2024, both of which are hereby incorporated by reference in their entirety.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### TECHNICAL FIELD

This disclosure relates to creating and maintaining cloud-attached computing clusters, and more particularly to techniques for support for using cloud network accessible (e.g., storage area network (SAN) and/or network-attached storage (NAS), and or direct-attached storage (DAS)) volumes in a multi-level storage tiering regime that is configured for quick failure recovery.

### BACKGROUND

Computing clusters running on cloud infrastructure are often provisioned onto cloud-specific bare-metal instance configurations. Unfortunately, such cloud-specific bare-metal instance configurations are deficient in terms of the amount and functionality of non-volatile storage offered. This deficiency often results in unwanted capacity and functionality limitations at the bare metal nodes of the computing cluster. More particularly, this deficiency often has the strongly unwanted consequence of protracted recovery times in the event of a loss of a node of the computing cluster.

What is needed are ways to configure computing cluster storage in a manner that concurrently overcomes the aforementioned deficiencies as pertain to (1) ongoing computing cluster performance, and (2) recovery to full capabilities after a loss of functionality of the computing cluster. The problem to be solved is therefore rooted in various technological limitations of legacy approaches. Improved technologies are needed. In particular, improved applications of technologies are needed to address the aforementioned technological limitations of legacy approaches.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and computer program products for implementing a heterogeneous storage tiering regime for high-performance failure recovery, which techniques advance the relevant technologies to address technological issues with legacy approaches. More specifically, the present disclosure describes techniques used in systems, methods, and in computer program products for implementing a heterogeneous storage tiering regime for high-performance failure recovery of a node of a computing cluster. Certain embodiments are directed to technological solutions for implementing a heterogeneous storage tiering regime for high-performance failure recovery of a node of a computing cluster.

The disclosed embodiments modify and improve beyond legacy approaches. In particular, the herein-disclosed techniques provide technical solutions that address the technical problems attendant to computing clusters that need to be configured for high availability data replication yet without unduly consuming performance tier capacity. Such technical solutions involve specific implementations (e.g., data organization, data communication paths, module-to-module interrelationships, etc.) that relate to the software arts for improving computer functionality. Various applications of the herein-disclosed improvements in computer functionality serve to reduce demand for computer memory, reduce demand for computer processing power, reduce network bandwidth usage, and reduce demand for intercomponent communication.

For example, when performing computer operations that address the various technical problems underlying computing clusters need to be configured for high availability data replication yet without unduly consuming performance tier capacity, both memory usage and CPU cycles demanded are significantly reduced as compared to the memory usage and CPU cycles that would be needed but for practice of the herein-disclosed techniques for implementing a heterogeneous storage tiering regime for high-performance failure recovery of a node of a computing cluster. Strictly as one case, the data structures as disclosed herein and their use serve to reduce both memory usage and CPU cycles as compared to alternative approaches. Moreover, information that is received during operation of the embodiments is transformed by the processes that store data into and retrieve data from the aforementioned data structures.

The ordered combination of steps of the embodiments serve in the context of practical applications that perform steps for implementing a heterogeneous storage tiering regime for high-performance failure recovery of a node of a computing cluster more efficiently. As such, techniques for implementing a heterogeneous storage tiering regime for high-performance failure recovery of a node of a computing cluster overcome long-standing yet heretofore unsolved technological problems associated with computing clusters that need to be configured for high availability data replication yet without unduly consuming performance tier capacity, which problems arise in the realm of computer systems.

Many of the herein-disclosed embodiments for implementing a heterogeneous storage tiering regime for high-performance failure recovery of a node of a computing cluster are technological solutions pertaining to technological problems that arise in the hardware and software arts that underlie computing clusters that use public cloud storage offerings. Aspects of the present disclosure achieve performance and other improvements in peripheral technical fields including, but not limited to, hyperconverged computing platform management and distributed storage systems.

Some embodiments include a sequence of instructions that are stored on a non-transitory computer readable medium. Such a sequence of instructions, when stored in memory and executed by one or more processors, causes the one or more processors to perform a set of acts for implementing a heterogeneous storage tiering regime for high-performance failure recovery of a node of a computing cluster.

Some embodiments include the aforementioned sequence of instructions that are stored in a memory, which memory is interfaced to one or more processors such that the one or more processors can execute the sequence of instructions to cause the one or more processors to implement acts for implementing a heterogeneous storage tiering regime for high-performance failure recovery of a node of a computing cluster.

In various embodiments, any combinations of any of the above can be organized to perform any variation of acts for implementing a heterogeneous storage tiering regime for high-performance failure recovery of a node of a computing cluster, and many such combinations of aspects of the above elements are contemplated.

Further details of aspects, objectives and advantages of the technological embodiments are described herein and in the figures and claims.

### BRIEF DESCRIPTION OF THE DRAWINGS

The drawings described below are for illustration purposes only. The drawings are not intended to limit the scope of the present disclosure.

FIG. 1A is an example bare metal computing cluster configuration that includes node-attached storage as a hot tier and network-accessible cloud-provided storage as a cold tier, according to an embodiment.

FIG. 1B is a sweet spot chart to exemplify reasoning that informs tradeoffs between node-local storage usage options with respect to remote storage usage options, according to an embodiment.

FIG. 1C depicts a first multi-tier storage regime configuration wherein node-level replicas of original data consume storage capacity of the hot tier, according to an embodiment.

FIG. 1D depicts a second multi-tier storage regime configuration wherein replicas of original data are stored in the cold tier, according to an embodiment.

FIG. 1E exemplifies a bare metal configuration that exhibits two logical storage tiers corresponding to two physical storage facility tiers.

FIG. 1F exemplifies an improved bare metal configuration that includes support for using cloud SAN volumes and node-local storage to implement multi-level promotion and demotion capability, according to an embodiment.

FIG. 1G depicts a multi-tiered storage architecture that facilitates fast recovery of failed nodes in a clustered virtualization system setting, according to an embodiment.

FIG. 2 is a flowchart that depicts a sequence of operations that serve to configure and use of bare metal nodes, according to an embodiment.

FIG. 3A is an example cold tier establishment protocol as used in systems that rely on network-accessible cloud-provided storage as a cold tier, according to an embodiment.

FIG. 3B is an example node configuration protocol for implementing a multi-tier storage regime as used in systems that have node-attached storage configured as a hot tier and network-accessible cloud-provided storage as a cold tier, according to an embodiment.

FIG. 4 is an example user interface as used in systems that have node-attached storage configured as a hot tier and network-accessible cloud-provided storage as a cold tier, according to an embodiment.

FIG. 5 is an example failure recovery protocol diagram as used in systems that have high-availability data replicas stored in a cloud-provided cold tier storage facility, according to an embodiment.

FIG. 6A and FIG. 6B depict ways to implement computer instructions that carry out a failure recovery protocol as used in systems that have high-availability data replicas stored in a cloud-provided cold tier storage facility, according to an embodiment.

FIG. 7A, FIG. 7B, FIG. 7C, and FIG. 7D depict virtualization system architectures comprising collections of interconnected components suitable for implementing embodiments of the present disclosure and/or for use in the herein-described environments.

### DETAILED DESCRIPTION

Aspects of the present disclosure solve problems associated with using computer systems for computing clusters that need to be configured for high availability data replication yet without unduly consuming performance tier capacity. These problems are unique to, and may have been created by, various computer-implemented methods for computing clusters that need to be configured for high availability data replication yet without unduly consuming performance tier capacity in the context of computing clusters that use public cloud storage offerings. Some embodiments are directed to approaches for implementing a heterogeneous storage tiering regime for high-performance failure recovery of a node of a computing cluster. The accompanying figures and discussions herein present example environments, systems, methods, and computer program products for implementing a heterogeneous storage tiering regime for high-performance failure recovery of a node of a computing cluster.

### Overview

When using cloud computing infrastructure (e.g., Amazon web services (AWS)), there are typically fixed configurations for bare metal instances. Beyond selecting the specific type of bare metal instance, users cannot configure the available storage attached to these instances. This limitation can force users to choose configurations where either the CPU, storage, or memory is in excess (or deficiency) of their requirements. Moreover, when using present day Amazon web services (AWS), only a single storage tier (for a so called “performance tier”) is supported. Unfortunately, the only way to add capacity is to add more compute nodes—which is often a cost-prohibitive approach—especially when the need is only to add more storage without additional compute requirements. As such, use of a cold tier (e.g., an elastic block storage replica tier) for replica storage in cloud native environments is proposed.

As used herein, a “replica” or “replica storage” refers to a copy of data in the form of a block or extent that is stored in response to a replication factor (RF) setting or configuration (e.g., RF=2, RF=3, etc.). Such a replica is different than data of a snapshot or data of a backup volume at least in the sense that a snapshot or backup volume needs to be processed in order to extract a block or extent from the snapshot or backup volume, whereas a replica of a block or extent stored in a lower tier (e.g., in a ‘cold’ tier) can be brought into a higher tier (e.g., into a ‘hot’ tier) merely by promotion of the replica from the lower tier into the higher tier; thus eliminating the processing involved in extraction from the snapshot or backup volume.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

As used herein, a heterogeneous storage tiering regime refers to a process that employs two different groupings of persistent storage devices where a first grouping of devices are accessed by a first method and where a second grouping of devices are accessed by a second method. For example, a first method may involve access via a motherboard-supported bus or fabric (e.g., non-volatile memory express (NVMe)) and where a second method may involve access via a local area network protocol such as a transmission control protocol (e.g., elastic block storage (EBS) or a general purpose EBS volume access (GP3)).

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiment even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

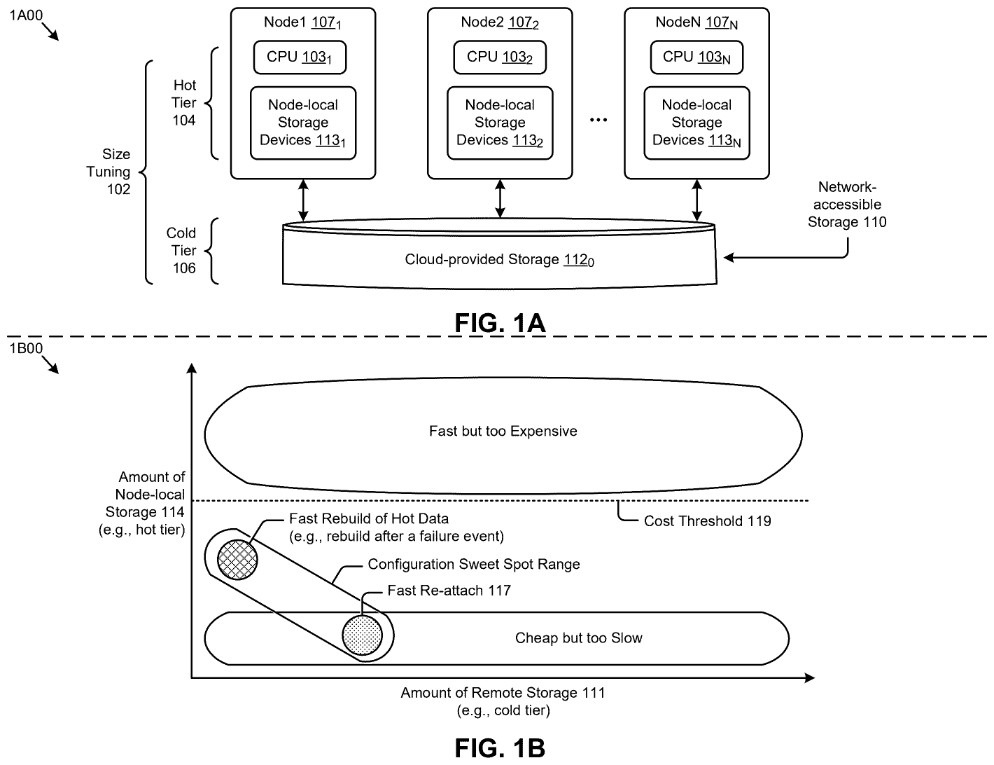

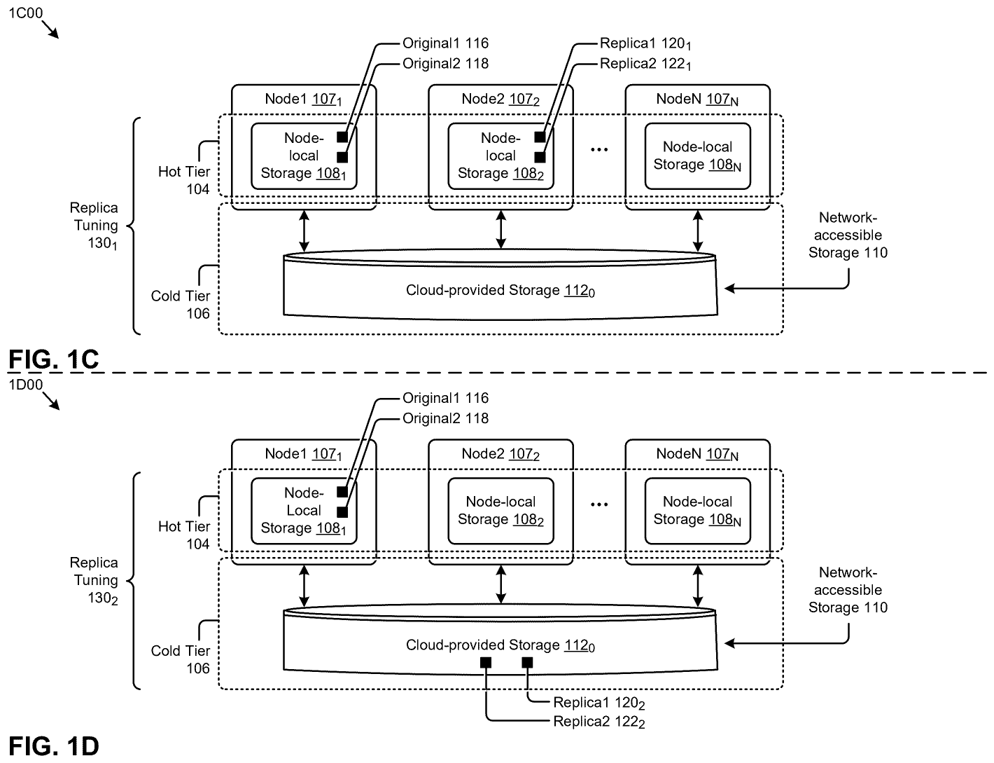

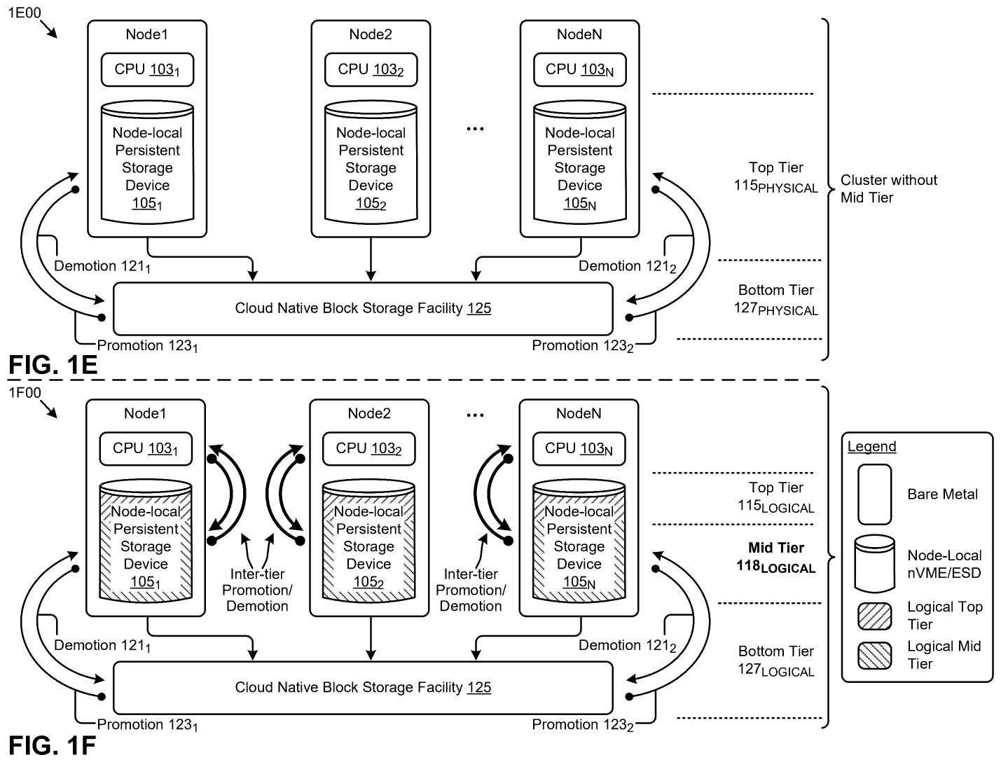

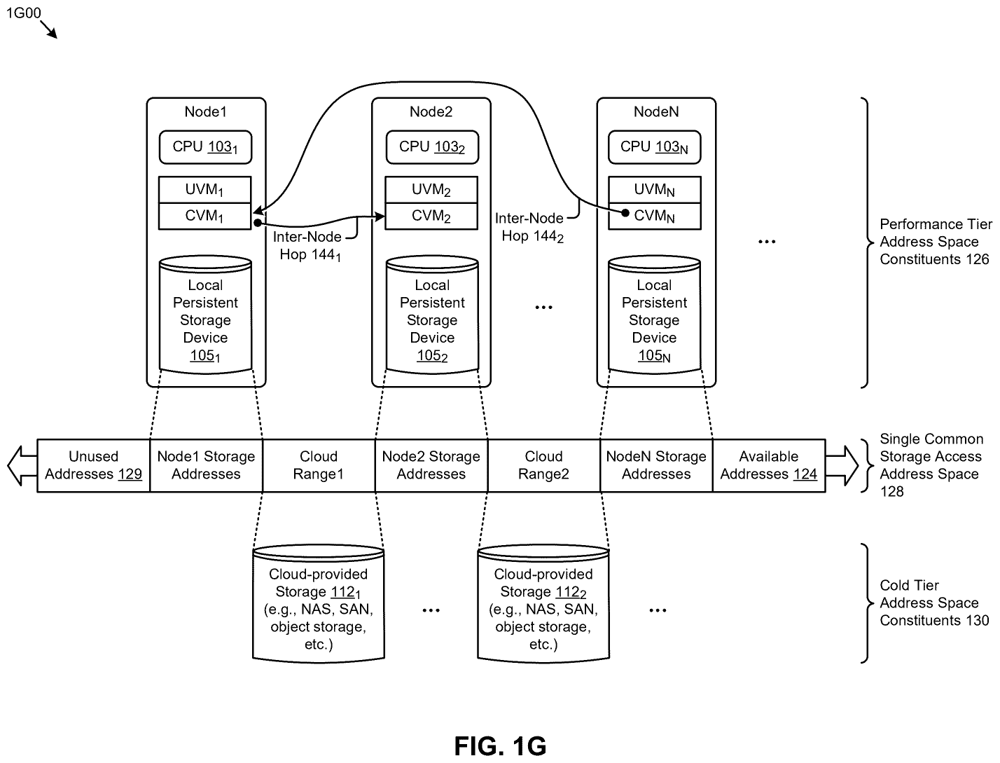

FIG. 1A is an example bare metal computing cluster configuration that includes node-attached storage as a hot tier and network-accessible cloud-provided storage as a cold tier. As an option, one or more variations of bare metal computing cluster configuration 1A00 or any aspect thereof may be implemented in the context of the architecture and functionality of the embodiments described herein and/or in any environment.

FIG. 1A exemplifies a computing cluster formed of a plurality of nodes (e.g., node 107₁, node 107₂, . . . , node 107_{N}), each having a CPU (e.g., CPU 103₁, CPU 103₂, . . . , CPU 103_{N}) that implement a storage tiering regime wherein a hot tier 104 is formed of node-local storage devices (e.g., NVMe SSDs) and wherein a cold tier 106 is formed of cloud-provided storage 112₀. The amount of storage provided by the node-local storage devices (e.g., node-local storage devices 113₁, node-local storage devices 113₂, . . . , node-local storage devices 113_{N}) as compared to the amount of storage provided by the cloud-provided storage (e.g., network-accessible storage 110) depends on size tuning 102. The size tuning can in turn depend on acceptability of tradeoffs between the amounts of (faster) node-local storage versus the amounts of (slower) cloud-provided storage.

FIG. 1B is a sweet spot chart to exemplify reasoning that informs tradeoffs between node-local storage usage options with respect to remote storage usage options. As an option, one or more variations of sweet spot chart 1B00 or any aspect thereof may be implemented in the context of the architecture and functionality of the embodiments described herein and/or in any environment.

FIG. 1B exemplifies one way to consider tradeoffs between the amounts of (faster) node-local storage 114 versus the amounts of (slower) remote storage 111 (e.g., cloud-provided storage devices). As shown, there is a configuration sweet spot range, which range involves some portion of (faster) node-local storage devices (e.g., for fast rebuild of hot data) and some portion of (slower) cloud-provided storage (e.g., fast re-attach 117). The tradeoffs as pertains to one selection of a particular sweet spot in the sweet spot range versus another, different sweet spot in the sweet spot range involve usage of (expensive, faster) node-attached storage (e.g., fast but too expensive) for fast read/write performance versus usage of (cheaper, slower) cloud-provided storage. As shown, a cost threshold 119 is used to identify when a given data object has moved outside the cost performance sweet spot of its current storage tier.

### Fast Rebuild in Failure Scenario

As can be seen, the sweet spot involves some amount of (expensive, faster) node-attached storage for fast hot-tier data rebuild in event of a failure and some amount of (cheaper, slower) cloud-provided storage for fast re-attach of cold-tier data. This has implications for configuring replication for high availability of the cluster. Specifically, since the aforementioned fast re-attach of cold-tier data is quite fast, it is reasonable to use the cold tier for replica storage to be used in a rebuild situation after a failure.

Consider the case of replica storage where the replica storage factor (RF) is RF=2 (meaning to always have one original as well as one copy). If the replica is stored in the cloud-provided storage, rather than in the node-local storage, then that effectively doubles the available NVMe tier capacity (which would have been halved if the replica were to be stored in node-local NVMe SSD). The tradeoff here is that although storing the replica copy in cloud-provided storage will exhibit slower reads as compared to storing the replica copy NVME SSD, it is now clear that doing so has the desirable effect of effectively doubling the NVME capacity since all RF2 copies are in the cloud-provided storage rather than in the node-local NVME SSD. The foregoing tradeoff is illustrated graphically by comparing FIG. 1C to FIG. 1D.

FIG. 1C depicts a first multi-tier storage regime configuration wherein node-local replicas of original data consume storage capacity of the hot tier. As an option, one or more variations of multi-tier storage regime configuration 1C00 or any aspect thereof may be implemented in the context of the architecture and functionality of the embodiments described herein and/or in any environment.

FIG. 1C exemplifies the situation where node-local storage (e.g., node-local storage 108₁, node-local storage 108₂, node-local storage 108_{N}) is configured to store an original portion of hot data (e.g., original1 116, original2 118) in a hot tier (e.g., in NVMe SSD devices, etc.) as well as its replica (e.g., replica1 120₁, replica2 122₁) that is also stored in the hot tier 104. As can be seen, storage capacity in the hot tier is consumed by storage of the node-local replicas. This results in unwanted consumption of hot tier capacity, which is unwanted especially since the alternative of storing replicas in the cold tier has nearly no impact on ongoing performance, excepting for incurring a very acceptable slightly longer rebuild time in the event of a rebuild after a failure event, which as is known in the art, is statistically rare. FIG. 1D exemplifies the situation where only the original hot data is stored in the hot tier, whereas its replica is stored in the cold tier.

FIG. 1D depicts a second multi-tier storage regime configuration wherein data replicas of original data are stored in the cold tier. As an option, one or more variations of multi-tier storage regime configuration 1D00 or any aspect thereof may be implemented in the context of the architecture and functionality of the embodiments described herein and/or in any environment.

FIG. 1D exemplifies the situation where an original portion of hot data (e.g., original1 116, original2 118) is stored in a hot tier (e.g., in NVMe SSD devices, etc.), whereas replicas (e.g., replica1 120₂, replica2 122₂) are stored in cold tier 106 (e.g., in cloud-provided storage 112₀). This manner of storing replicas in the cold tier has nearly no impact on ongoing performance except for incurring a very acceptable, slightly longer rebuild time in the event of rebuild after a failure event, which as is known in the art is statistically rare.

FIG. 1E exemplifies a bare metal configuration that exhibits two logical storage tiers corresponding to two physical storage facility tiers. As an option, one or more variations of bare metal configuration 1E00 or any aspect thereof may be implemented in the context of the architecture and functionality of the embodiments described herein and/or in any environment.

As can be seen, stored items can be promoted or demoted (or demoted then promoted or promoted then demoted) flexibly between the node-local persistent storage devices of each node and the shown cloud native block storage facility 125. This serves to implement a cluster with two tiers of storage (e.g., the shown top tier 115_{PHYSICAL} and the shown bottom tier 127_{PHYSICAL}). The foregoing depicts merely some possible embodiments, however the embodiment can be improved by defining the bounds of a middle tier (e.g., defining the middle tier bounds logically between the shown top tier 115_{PHYSICAL} and the shown bottom tier 127_{PHYSICAL}). It should be noted that the shown bottom tier 127_{LOGICAL} is merely the lowest shown tier, and there may be further one or more even still lower tiers in operation (e.g., for long-term storage such as to accommodate a governance/retention policy).

FIG. 1F exemplifies an improved bare metal configuration that includes support for using cloud SAN volumes and node-local storage to implement multi-level promotion and demotion capabilities. As an option, one or more variations of bare metal configuration 1F00 or any aspect thereof may be implemented in the context of the architecture and functionality of the embodiments described herein and/or in any environment.

FIG. 1F depicts such a configuration where node-local storage (e.g., the node-local persistent storage devices of each node) are logically divided to include a high-performance tier of the node-local persistent storage devices. More specifically, FIG. 1F exemplifies an improved bare metal configuration that includes support for using cloud network accessible (e.g., SAN) volumes and node-local storage to implement tri-level storage tiering.

The shown top tier of local storage (e.g., the shown top tier 115_{LOGICAL}) is configured to be a high-performance tier. A middle tier is also situated in local storage (e.g., the shown mid tier 118_{LOGICAL}). As such, both the top tier and the middle tier are hosted on the node-local persistent storage devices of a particular node. Stored items can be promoted or demoted (or demoted then promoted or promoted then demoted) flexibly between the foregoing two logical storage tiers as well as between the mid tier of the node-local persistent storage devices and the shown cloud native block storage facility. This then is one possible remedy to the problems/limitations that force users to choose configurations where either the CPU, storage, or memory is in excess (or deficiency) of their requirements.

The foregoing discussions of FIG. 1E and FIG. 1F pertain to merely some possible embodiments and/or ways to implement a bare metal configuration. Many variations are possible, for example, the bare metal configuration as comprehended in the foregoing can be implemented in any environment, one example of which is shown and described as pertains to the following figure.

FIG. 1G depicts a multi-tiered storage architecture that facilitates fast recovery of failed nodes in a clustered virtualization system setting. The clustered virtualization system avails of a high-performance communication mechanism over an address space that is formed of combinations of node-local storage devices (e.g., node-internal storage devices) together with cloud-provided storage (e.g., cloud-provided network-attached storage, cloud-provided storage area networks, etc.). As an option, one or more variations architecture 1G00 or any aspect thereof may be implemented in any of the embodiments described herein and/or in any environment.

FIG. 1G is being shown to illustrate one configuration of a computing cluster having at least two nodes (e.g., node node1, node node2, . . . , node nodeN), the at least two nodes hosting virtualized entities (e.g., user virtual machine UVM₁, user virtual machine UVM₂, . . . , user virtual machine UVM_{N}) that are accessible by the at least two nodes via a common logical address space (e.g., single common storage access address space 128, and the at least two nodes having respective one or more node-local non-volatile storage devices (e.g., node-local persistent storage device 105₁, node-local persistent storage device 105₂, . . . , node-local persistent storage device 105_{N}, NVMe SSD devices, etc.).

As depicted in this embodiment, the nodes within a cluster comprise performance tier address space constituents 126 (e.g., node-local persistent storage device 105₁, node-local persistent storage device 105₂, . . . , node-local persistent storage device 105_{N}, NVMe SSD devices, etc.). As shown, the nodes host one or more user virtual machines (e.g., user virtual machine UVM₁, user virtual machine UVM₂, . . . , user virtual machine UVM_{N}). Furthermore, each node hosts a node-specific control virtual machine (e.g., control virtual machine CVM₁, control virtual machine CVM₂, . . . , control virtual machine CVM_{N}). The nodes communicate with one another over the shown single common storage access address space 128. The single common storage access address space 128 is formed of a plurality of independently accessible storage devices, including both local storage (e.g., using node-internal storage devices) and any forms of network-accessible storage, which are organized (e.g., concatenated) to form a storage pool. The single common storage access address space 128 may have non-contiguous segments of addresses and/or unused segments of addresses (e.g., available addresses 124 or unused 129 addresses). Such shared/common address spaces can be sized to be accessed conveniently by a 64-bit processor. This gives a potential address space that is on the order of 10×10¹⁸ addresses. However, there are modern computing situations where the extent of stored items, especially as pertains to long-term storage, may exceed that extent. In such cases, a storage tier even lower than the cold tier, as may be provided by the cloud infrastructure, might offer still further object storage (e.g., blob storage, glacier tier storage, etc.)

As is known in the art, it often happens that, over time, the amount of data generated by an application, possibly to be retained in order to satisfy some retention policy, or some other reason, may far exceed the available storage capacity of even a fully configured node-local persistent storage device. Accordingly, in the case of overflow into a lower tier of storage and, more specifically, overflow from the so-called mid-tier (see FIG. 1F), mid-tier data can be offloaded (e.g., demoted) to cloud-provided network-attached storage (e.g., see cold tier address space constituents 130). It may also happen that cloud provided storage 112₁ and/or cloud provided storage 112₂ may themselves overflow, in which case data can be offloaded (e.g., demoted) to still colder tier storage (e.g., glacier storage or similar long-term extremely low-access storage).

As shown by the inter-node hops (e.g., inter-node hop 144₁, inter-node hop 144₂), any control virtual machine can process a request to access any address of the single common storage access address space. More specifically, any CVM can know the identity of the node that should be accessing the single common storage access space in order to satisfy the request. For example, CVM1 might receive a request that is destined for Node2 addresses, in which case the request would be forwarded to CVM2. Similarly, NodeN might receive a request for access to some portion of the single common storage access address space that does not correspond to NodeN. For example, NodeN might receive a request for access to an address corresponding to a Node1 address, in which case the request would be forwarded by the CVM_{N} of NodeN to the CVM₁ of Node1.

Unfortunately, in some cases node functionality may be disrupted (e.g., due to network malfunction and/or CPU unavailability, etc.) leading to loss of access to the addresses corresponding to the disrupted node. Accordingly, there is a need for mechanisms to remediate (e.g., to minimize node downtime so as to accomplish high-performance node failure recovery). The following is a flowchart depicting a sequence of operations that are carried out so as to facilitate failure recovery.

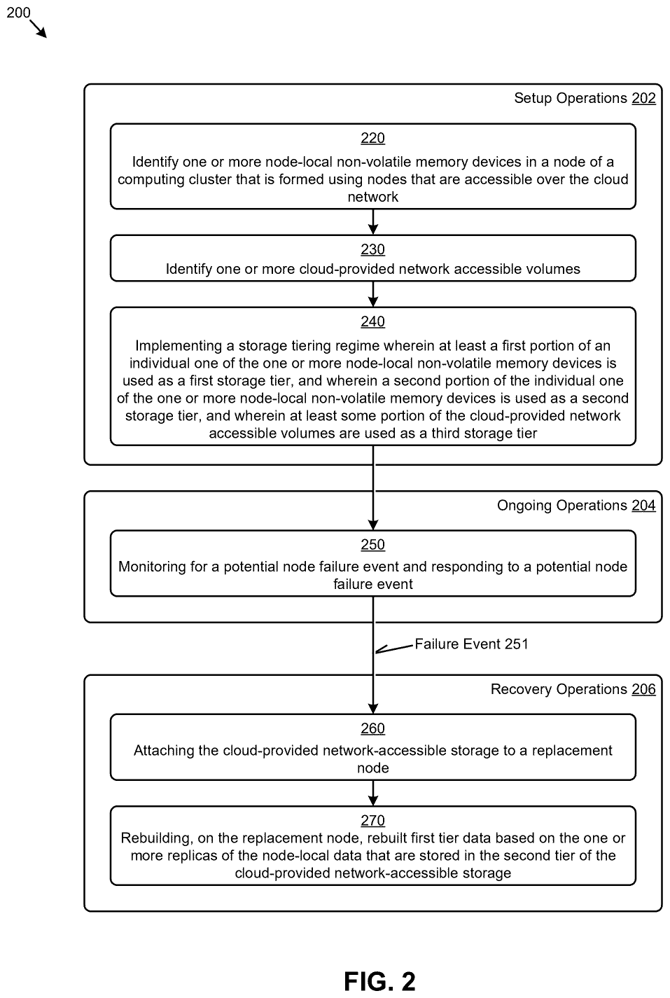

FIG. 2 is a flowchart that depicts a sequence of operations that serve to configure and exploit use of the foregoing bare metal configuration. As an option, one or more variations of sequence of operations 200 or any aspect thereof may be implemented in the context of the architecture and functionality of the embodiments described herein and/or in any environment.

FIG. 2 exemplifies a flowchart of operations wherein characteristics of the foregoing architecture and applicable configurations can be exploited in order to implement high performance failure recovery. In order to implement high performance recovery, various operations must be performed to deploy a configuration that supports high performance node-level recovery. As shown, the setup operations 202 serve to configure storage tiering, wherein node-local attached storage is designated as a first tier and cloud-provided storage is designated as a second tier. One specific flow through setup operations 202 involves identification of one or more node-local non-volatile memory devices (e.g., any number of node-local non-volatile storage devices) in a node of a computing cluster that is formed using nodes that are accessible over the cloud network (step 220). Frequently accessed data will be stored in such node-local nonvolatile memory devices (e.g., NVMe SSDs).

When one or more one or more node-local non-volatile memory devices in a node of a computing cluster have been identified, identification of one or more cloud-provided network accessible volumes (step 230) will be executed. This is because the cloud-provided network accessible volumes (designated as the cold-tier in a subsequent step) will need to store demoted data based on observations of data access within the tier (e.g., observation of low frequency data access). These observations may inform how to maintain a hot-tier index, which in turn informs how stored data is to be demoted or promoted (e.g., based on such observations, and/or based on statistics performed over the observations). In some failure/rebuild situations, the rebuilt first storage tier data includes rebuilding of a hot-tier index. It should be noted that there may be as many unique hot-tier indexes as there are nodes of the computing cluster. In fact, it often happens that each and every one of the many unique hot-tier indexes are different for each node (e.g., based on the recent computing activities carried out by a particular node).

Once candidates for the first storage tier (e.g., formed of node-local non-volatile memory devices) and candidates for the second storage tier(s) (e.g., cloud-provided network accessible volumes) have been determined, storage of data items into the appropriate tier can be performed (e.g., through the process of demotions and promotions). However, to facilitate ongoing demotion and promotion of data between tiers (e.g., via inter-tier promotions/demotions), a storage tiering initialization and ongoing management regime is implemented.

One such embodiment involves implementing a three-level storage tiering regime (step 240) wherein at least a first portion of an individual one of the one or more node-local non-volatile memory devices is used as a first storage tier, and wherein a second portion of the individual one of the one or more node-local non-volatile memory devices is used as a second storage tier, and wherein at least some portion of the cloud-provided network accessible volumes are used as a third storage tier. In this embodiment the tiering regime is implemented for the processing of ongoing I/O (input/output or IO) operations, thus enabling handling of data in a manner that meets specified parameters (e.g., high I/O frequency access, low I/O frequency access, residence time(s), etc.) such that data is promoted or demoted into an appropriate storage tier (e.g., top tier, mid tier, bottom tier).

Referring again to the embodiments as depicted in FIG. 1F, the top tier of local storage (e.g., the shown top tier 115_{LOGICAL}) is configured to be a high-performance tier. A middle tier also situated in local storage (e.g., the shown mid tier 118_{LOGICAL}) and, as such, both the top tier and the middle tier are hosted on the node-local persistent storage devices of a particular node. Stored items can be promoted or demoted (or demoted then promoted or promoted then demoted) flexibly between the foregoing two logical storage tiers as well as into and out of the mid tier of the node-local persistent storage devices. Similarly, stored items can be promoted or demoted into and out of the cloud native block storage facility. This is exemplified by the acts shown as demotion 121₁, demotion 121₂, promotion 123₁, and promotion 123₂.

Once the setup operations have been executed, the flowchart proceeds to ongoing operations 204 (e.g., I/O requests). During ongoing operations, monitoring and processing of I/O requests is continuously carried out. In some embodiments, a tier manager identifies each read or write request and consults tiering metadata to identify whether the data resides in the upper tiers (e.g., as in a node-local NVMe component) or in the lower tier (e.g., as in a cloud-attached volume). The I/O request is then forwarded to the appropriate location. Each access increments usage counters (e.g., access frequency) and these metrics are logged for evaluation and/or stored in the tiering metadata. In one embodiment a tier manager can analyze the collected metrics. Data whose access frequency breaches (e.g., falls below) a demotion threshold is moved (e.g., demoted) from a hotter tier to a colder tier. Specifically, infrequently accessed replicas of node-local data in a cluster can be demoted to the bottom tier. Conversely, data in the bottom tier whose access frequency breaches (e.g., exceeds) a promotion threshold is moved into the hot tier for faster access. Unfortunately, loss of functionality of a node may occur. Monitoring for a potential node failure event and responding to a potential node failure event (step 250) can be implemented so as to mitigate loss of functionality in the face of a node failure.

Monitoring and responding to a potential node failure can be accomplished using any known technique. Upon detection of a loss of functionality, various information (e.g., number of failed disks, status of the local area network, status of a witness process, etc.) is gathered to confirm a loss of functionality has indeed occurred. Upon confirmation of a loss of functionality, acquisition of still further types of information as might be needed for initiation of recovery operations is collected. In one embodiment, an agent (e.g., any of various forms of a multi-cluster manager) within the system may receive the failure event notification and initiate communication to obtain such further types of information such as health metrics, current status of a faulty node, location of the deemed faulty node, replacement node location, etc.

It should be noted that in legacy implementations of computing nodes that are situated in a particular failure domain, it often happens (in such legacy implementations) that if a node fails, the storage facilities in that same particular failure domain also fail, or at least are deemed to have failed. This sets up the unwanted situation where backup data needs to be accessed in order to complete recovery operations. In many such situations, this negatively impacts recovery times, possibly exceeding the system's recovery time objective. Furthermore, in the event that backup data needs to be accessed in order to complete recovery operations, it often happens that a large amount of infrastructure resources are consumed to accomplish the recovery, possibly involving multiple network hops and possibly involving infrastructure middleware. This is because backup volumes tend to be distally located (e.g., to comport with disaster recovery parameters). To explain, if backup volumes are distally located (e.g., in a different country, in a different city, in a different building, in a different floor, etc.), then the recovery operations (e.g., rebuild of data volumes) might be impaired by network latency that is incurred as a consequence of the backup data being distally located from the replacement node. However, in the situation where the storage media is composed of subject cloud-provided storage volumes, it can be assumed that such cloud-provided storage media did not fail, and as such, can be accessed almost immediately by a replacement node upon re-attachment of the subject cloud-provided storage volumes to the replacement node(s). This capability of being able to re-attach the subject cloud-provided storage volumes to the replacement node(s) means that (1) recovery operations at the replacement node do not suffer from latency that is any worse than was present in the failed node, and (2) since the time window during which the recovery operations are carried out is short, it follows that the time window during which a second failure might occur is also commensurately short. This in turn greatly reduces the likelihood of a second failure during the rebuild which in turn greatly reduces the likelihood that a data loss event or sequence of events resulting in a data loss could occur in the system.

Now, returning to the discussion of FIG. 2, once the requisite information is collected, appropriate initiation of recovery operations 206 can commence. Once the requisite information is collected, appropriate initiation of recovery operations 206 can commence.

One specific flow involving initiation of recovery operations 206 is shown as commencing upon detection of a failure event 251. The shown flow involves attaching the cloud-provided network-accessible storage to a replacement node (step 260). One of skill in the art will recognize that the act of attaching the cloud-provided network-attached storage to a replacement node is a logical operation that does not involve/require moving large amounts data from whatever non-replacement node location(s) to the replacement node. As such, configuring the replacement node to have access to the potentially huge volume of cold tier data can happen in, for example, a single API call.

Upon successful attachment of the cloud-provided network-attached storage to the replacement node, the replacement node can thereafter read from and write to the cloud-provided network-attached storage. Upon execution of step 260 the flowchart proceeds to the subsequent recovery operation step, which serves to rebuild, on the replacement node, rebuilt first tier data based on the one or more replicas of the node-local data that are stored in the second tier of the cloud-provided network-accessible storage (step 270). As such, by enabling rapid re-attachment and rebuilding, which in turn minimizes downtime during node rebuild operations, the time window for a potential second node failure event is greatly reduced, thereby nearly eliminating the possibility for a double node failure situation.

Having rebuilt the needed data on the replacement node, the system may proceed to return to normal operations. To continue monitoring for anomalous conditions, at least one processing thread can return to ongoing operations 204.

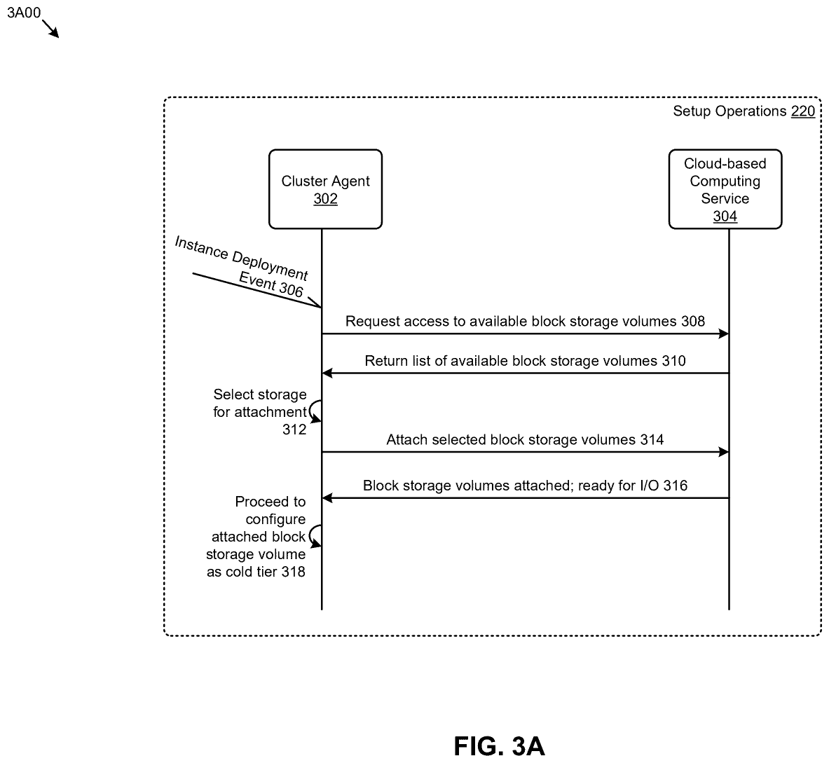

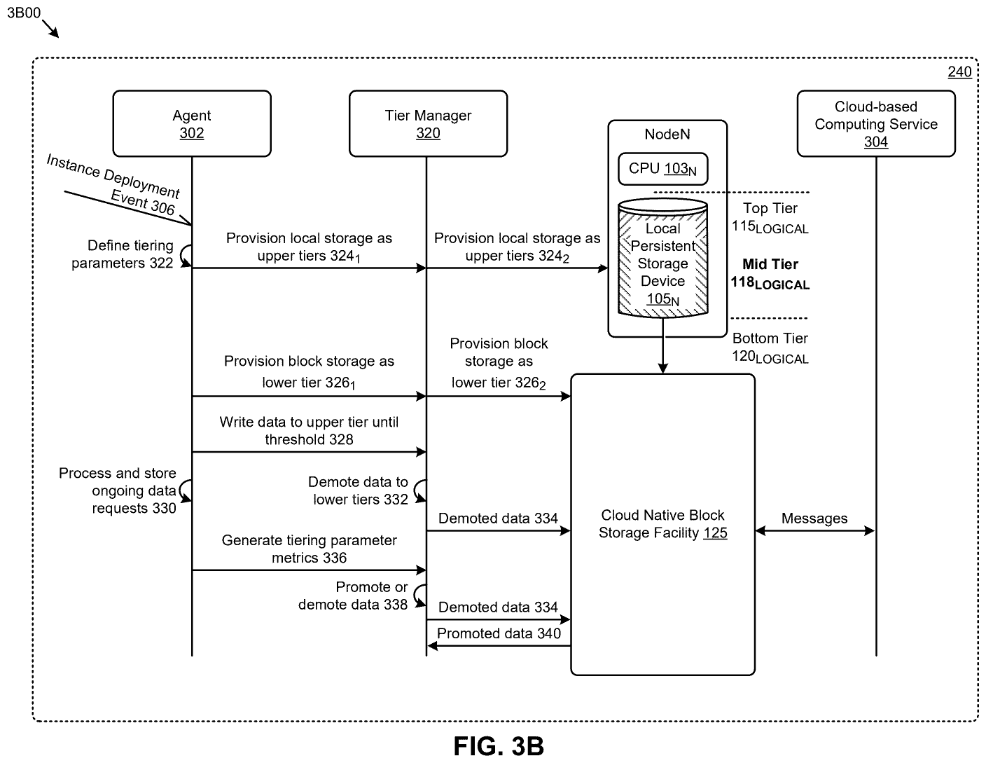

The foregoing discussion of FIG. 2 pertains to merely some possible embodiments and/or ways to implement a sequence of operations. Many variations are possible, for example, the sequence of operations as comprehended in the foregoing can be implemented in any environment, one example of which is shown and described as pertains to the following figures. To provide a detailed breakdown of the setup operations, a protocol diagram is presented in FIG. 3A and FIG. 3B, illustrating the sequence of messages and actions performed by each system component.

FIG. 3A is an example cold tier establishment protocol as used in systems that rely on cloud-provided storage as a cold tier. As an option, one or more variations of cold tier establishment protocol 3A00 or any aspect thereof may be implemented in the context of the architecture and functionality of the embodiments described herein and/or in any environment.

FIG. 3A illustrates a protocol exchange between cluster agent 302 and cloud-based computing service 304. Results of the shown protocol exchange include generation of a cold tier establishment as used in systems that rely on an initial setup operation in a high-performance failure recovery process. As shown, the protocol commences upon an instance deployment event 306. In this embodiment, cluster agent 302 (e.g., hypervisor, multi-cluster manager, etc.) receives the instance deployment event notification. Upon receiving the instance deployment event notification, the cluster agent requests access to available block storage volumes. In the particular embodiment shown, message 308 is sent to the cloud-based computing service 304. This is done in order to obtain the available block storage volumes that can be attached and later designated as the cold tier (e.g., via operation 318). Once message 308 is received by cloud-based computing service 304 the cloud-based computing service returns a list of available block storage volumes (message 310).

As such, in this embodiment, one or more block storage volumes from the list are selected for attachment (operation 312) and a message (message 314) requesting attachment of a block storage volume is sent to the cloud-based computing service. Upon completion of block storage volumes being attached, the cloud-based computing service will return message 316 that block storage volumes have been attached and are ready for I/O to the cluster agent. As a result, the cluster agent will now be able to use the attached block storage volume as a cold tier. Additionally, and as known to one of ordinary skill in the art, a similar protocol diagram can be applied to determining appropriate storage nodes as a hot tier. Upon predetermination of the hot and cold tiers, a tiering regime is established. To illustrate this regime, FIG. 3B presents a protocol diagram of the multi-tiering operations.

The foregoing discussion of FIG. 3A pertains to merely some possible embodiments and/or ways to implement a cold tier establishment protocol. Many variations are possible, for example, the cold tier establishment protocol as comprehended in the foregoing can be implemented in any environment, one example of which is shown and described as pertains to FIG. 3B.

FIG. 3B is an example node configuration protocol for implementing a multi-tier storage regime as used in systems that have node-attached storage configured as a hot tier and cloud-provided storage as a cold tier. As an option, one or more variations of node configuration protocol 3B00 or any aspect thereof may be implemented in the context of the architecture and functionality of the embodiments described herein and/or in any environment.

FIG. 3B illustrates a node configuration protocol for implementing a multi-tier storage regime as used in systems that have node-attached storage configured as a hot tier and cloud-provided storage configured as a cold tier, and as used in systems that rely on initial setup operations in a high-performance failure recovery process as illustrated and described in FIG. 2.

One specific flow through the protocol diagram first involves an instance deployment event 306. Upon the instance deployment event, the protocol diagram continues with a cluster agent 302 (e.g., hypervisor, multi-cluster manager, etc.) executing an operation to define tiering parameters 322 (e.g., watermark threshold, read/write access frequency metrics) for the cold tier (e.g., block storage) and the hot tier (e.g., node-local non-volatile memory device). The cluster agent issues provision requests to provision local storage as upper tiers (e.g., message 324₁, and message 324₂) as well as to provision block storage as lower tier (e.g., message 326₁, and message 326₂) in order to configure a tiered storage architecture. The cluster agent then issues a request (e.g., via message 328 to “write data to upper tier”) to the tier manager to store all incoming data in the upper tiers (e.g., top tier, mid tier) until the predefined threshold parameter is reached. This is done in order to facilitate high-throughput and low-latency access to newly written data.

Upon reaching the defined threshold, the tier manager initiates an operation (e.g., to move demoted data 334 into lower tiers) to relocate data. The tier manager then sends a message (e.g., the shown “demote data to lower tiers 332” message) to the cloud-based storage service to demote the mid-tier data to a block storage volume in the bottom tier. The demotion serves to free up capacity in the high-performance storage tier for new or more frequently accessed data, thereby preserving the performance characteristics of the upper tiers. Additionally, relocating less frequently accessed data to lower-cost, high-capacity storage enables more efficient use of system resources and reduces overall storage cost.

Concurrently, a cluster agent or other sort of monitoring component continuously processes ongoing data requests (e.g., process and store ongoing data requests 330) and generates tiering parameter metrics 336 (e.g., access frequency, access patterns), which are supplied to the tier manager. The tier manager 320 in combination with cloud-based computing services 304 evaluates these metrics to determine whether to promote or demote data 338 in accordance with the current access frequencies and/or access patterns. In parallel, and in some cases, based solely on the analysis of such metrics, data may be promoted from a cloud-based computing service to the high-performance tier (e.g., via a promote data message 340) to facilitate improved read and write performance. The following figure illustrates one embodiment of a user interface that graphically implements the foregoing setup and ongoing operations.

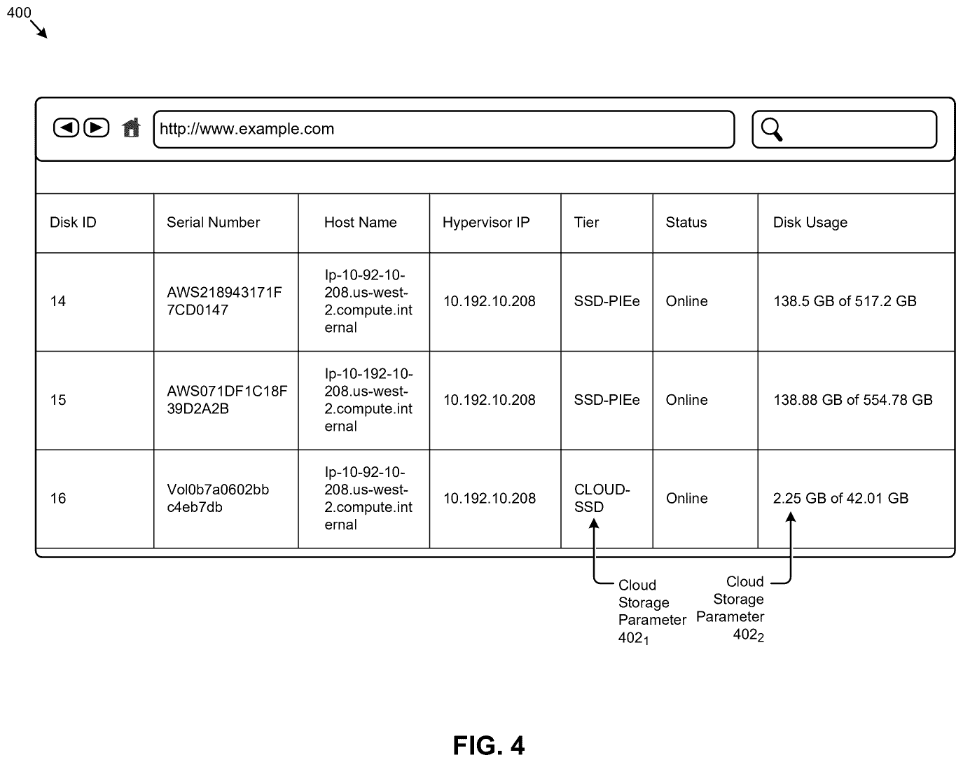

The foregoing discussion of FIG. 3B pertains to merely some possible embodiments and/or ways to implement a node configuration protocol. Many variations are possible, for example, the node configuration protocol as comprehended in the foregoing can be implemented in any environment, one example of which is shown and described as pertains to FIG. 4.

FIG. 4 is an example user interface as used in systems that have node-attached storage configured as a hot tier and cloud-provided storage as a cold tier. As an option, one or more variations of user interface 400 or any aspect thereof may be implemented in the context of the architecture and functionality of the embodiments described herein and/or in any environment.

FIG. 4 is presented to provide an example of how a cluster agent can interact with systems that have node-attached storage configured as a hot tier and cloud-provided storage configured as a cold tier through a user interface, enabling real-time provisioning of storage resources, configuration of data-tiering policies, and continuous monitoring of data placement and disk usage. In the depicted embodiment, the cluster agent can select volumes for the upper and lower tiers, adjust threshold parameters, and view metrics-all within a single view/dashboard. Upon completion of the setup, the system is ready to initiate high performance failure recovery operations.

As shown, in this embodiment, the user interface enables a user to select particular desired storage entities and to view parameters (e.g., cloud storage parameter 402₁, cloud storage parameter 402₂). The items available for selection may be present in the GUI based on successful provisioning of the corresponding storage resources. In the illustrated example, other storage types are designated as part of the SSD-PIEe tier. This designation reflects predefined tiering criteria, such as performance characteristics, data residency requirements, or storage medium type, which govern the classification and allocation of storage resources within the system.

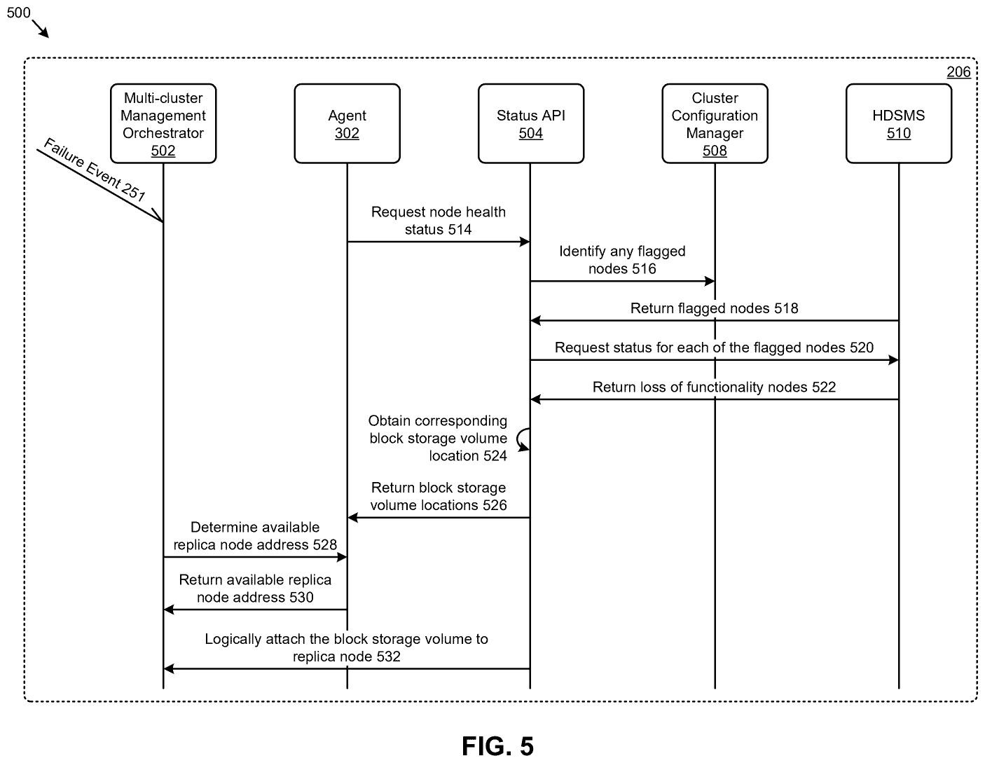

The foregoing discussion of FIG. 4 pertains to merely some possible embodiments and/or one possible way to implement a user interface. Many variations are possible, for example, the user interface as comprehended in the foregoing can be implemented in any environment, one example of which is shown and described as pertains to the following FIG. 5.

FIG. 5 is an example failure recovery protocol diagram as used in systems that have high-availability data replicas stored in a cloud-provided cold tier storage facility. As an option, one or more variations of failure recovery protocol 500 or any aspect thereof may be implemented in the context of the architecture and functionality of the embodiments described herein and/or in any environment.

FIG. 5 is presented to illustrate an example failure recovery protocol as used in systems that have high-availability data replicas stored in a cloud-provided cold tier storage facility. As shown, multi-cluster management orchestrator 502 and cluster agent 302 communicate to detect possible failure events or observed conditions. Upon detection of failure event 251, the cluster agent issues a node-status request (e.g., request node health status 514) to the status application programming interface (API). Upon receipt of the node health status request, the status API then issues a node flagged request (e.g., identify any flagged nodes message 516) to a cluster configuration manager 508. The hardware drive state management system (HDSMS) 510 then returns flagged nodes 518 to the status API. In response, the status API issues a request (e.g., request status for each of the flagged nodes message 520) for node-status for each flagged nodes to the HDSMS 510), and the hardware drive state management system returns each node that has lost functionality 522.

Consequently, the status API executes an operation to obtain corresponding block storage volume location 524 of the node that failed. The status API 504 returns the block storage volume information 526 to the cluster agent, which then forwards the information to the multi-cluster management orchestrator. The multi-cluster management orchestrator 502 sends a request to the cluster agent to determine available replica nodes and their corresponding addresses 528. The cluster agent returns available replica nodes and their addresses 530 to the multi-cluster management orchestrator. Accordingly, the status API issues a request to the multi-cluster management orchestrator to logically attach the block storage volume to replica node 532. This protocol diagram illustrates an example failure recovery protocol as used in systems that have high-availability data replicas stored in a cloud-provided cold tier storage facility

The foregoing discussion of FIG. 5 pertains to merely some possible embodiments and/or ways to implement a failure recovery protocol. Many variations are possible, for example, the failure recovery protocol as comprehended in the foregoing can be implemented in any environment, one example of which is shown and described as pertains to the following figures.

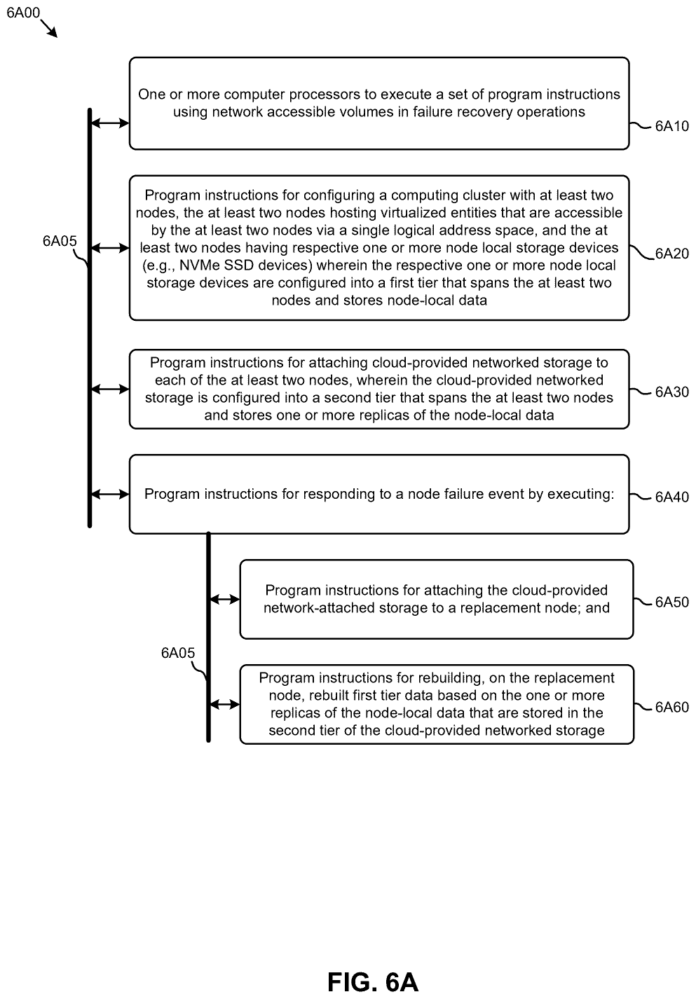

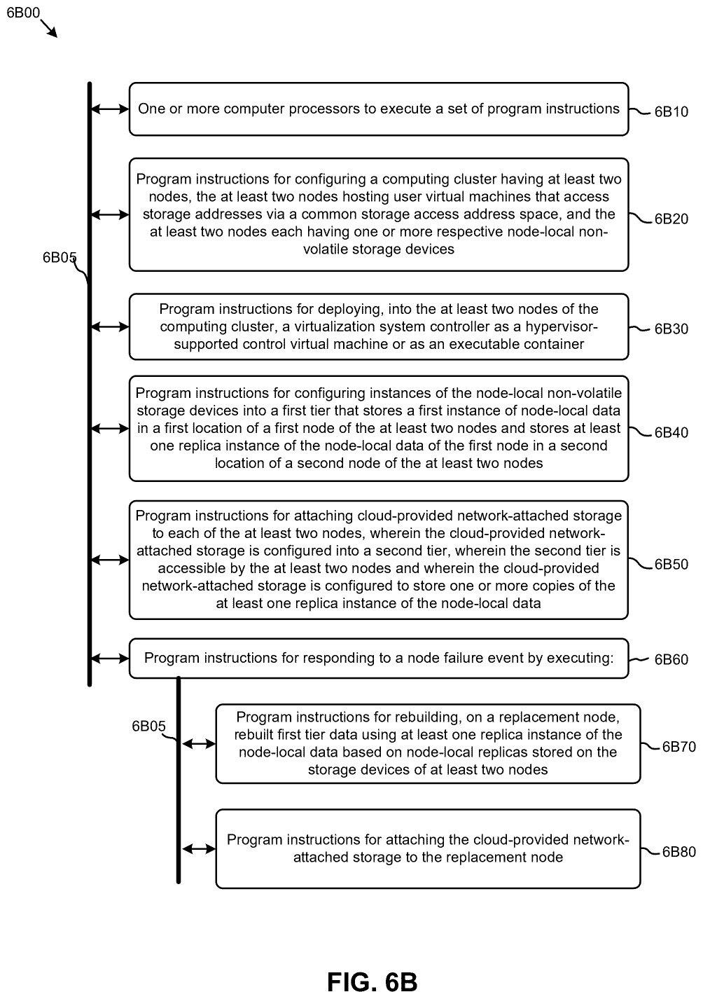

FIG. 6A and FIG. 6B depict ways to implement computer instructions that carry out a failure recovery protocol as used in systems that have high-availability data replicas stored in a cloud-provided cold tier storage facility.

FIG. 6A depicts a block diagram of a system to perform certain functions of a computer system. As an option, system 6A00 may be implemented in the context of the architecture and functionality of the embodiments described herein. Of course, however, the system 6A00 or any operation therein may be carried out in any desired environment. The system 6A00 comprises at least one processor and at least one memory, the memory serving to store program instructions corresponding to the operations of the system. As shown, an operation can be implemented in whole or in part using program instructions accessible by a module. The modules are connected to a communication path 6A05, and any operation can communicate with any other operations over communication path 6A05. The modules of the system can, individually or in combination, perform method operations within system 6A00. Any operations performed within system 6A00 may be performed in any order unless as may be specified in the claims. The shown embodiment implements a portion of a computer system, presented as system 6A00, comprising one or more computer processors to execute a set of program code instructions (module 6A10) and modules for accessing memory to hold program code instructions to perform: configuring a computing cluster having at least two nodes, the at least two nodes hosting virtualized entities that are configured to access a common storage access address space, and the at least two nodes having respective one or more node-local non-volatile storage devices wherein the respective one or more node-local non-volatile storage devices are configured into a first storage tier that stores node-local data (module 6A20); attaching cloud-provided network-attached storage to the at least two nodes, wherein the cloud-provided network-attached storage is configured into a second storage tier that stores one or more replicas of the node-local data (module 6A30); responding (module 6A40) to a node failure event by (1) attaching the cloud-provided network-attached storage to a replacement node (module 6A50) and (2) rebuilding, on a replacement node, rebuilt first storage tier data based on the one or more replicas of the node-local data that are stored in the second storage tier of the cloud-provided network-attached storage (module 6A60).

As used herein, the term “cloud-provided network-attached storage” refers to any sort of network-accessible storage such as all or portions of cloud-provided storage accessed as networked-attached storage (NAS) and/or all or portions of cloud-provided storage accessed as a storage area network (SAN) and/or all or portions of cloud-provided storage accessed as a network-accessible direct-attached storage fabric (DAS). In exemplary embodiments, the foregoing network-accessible storage is configured as additional cloud-provided storage that is available above and beyond any cloud-provided storage that might be present in any cloud-provided bare-metal node or as might be present in any cloud-provided compute node.

FIG. 6B depicts a block diagram of a system for configuring a computing agent to participate in failure recovery operations. As an option, system 6B00 may be implemented in the context of the architecture and functionality of the embodiments described herein. Of course, however, the system 6B00 or any operation therein may be carried out in any desired environment. The system 6B00 comprises at least one processor and at least one memory, the memory serving to store program instructions corresponding to the operations of the system. As shown, an operation can be implemented in whole or in part using program instructions accessible by a module. The modules are connected to a communication path 6B05, and any operation can communicate with any other operations over communication path 6B05. The modules of the system can, individually or in combination, perform method operations within system 6B00. Any operations performed within system 6B00 may be performed in any order unless as may be specified in the claims. The shown embodiment implements a portion of a computer system, presented as system 6B00, comprising one or more computer processors to execute a set of program code instructions (module 6B10) and modules for accessing memory to hold program code instructions to perform: configuring a computing cluster having at least two nodes, the at least two nodes hosting user virtual machines that access storage addresses via a common storage access address space, and the at least two nodes each having one or more respective node-local non-volatile storage devices (module 6B20); deploying, into the at least two nodes of the computing cluster, a virtualization system controller as a hypervisor-supported control virtual machine or as an executable container (module 6B30); configuring instances of the node-local non-volatile storage devices into a first tier that stores a first instance of node-local data in a first location of a first node of the at least two nodes and stores at least one replica instance of the node-local data of the first node in a second location of a second node of the at least two nodes (module 6B40); attaching the additional cloud-provided network-attached storage to each of the at least two nodes, wherein the cloud-provided network-attached storage is configured into a second tier, wherein the second tier is accessible by the at least two nodes and wherein the cloud-provided network-attached storage is configured to store one or more copies of the at least one replica instance of the node-local data (module 6B50); responding (module 6B60) to a node failure event by (1) rebuilding, on a replacement node, rebuilt first tier data using at least one replica instance of the node-local data based on node-local replicas stored on the storage devices of at least two nodes (module 6B70); and (2) attaching the cloud-provided network-attached storage to the replacement node (module 6B80).

### System Architecture Over View

### Additional System Architecture Examples

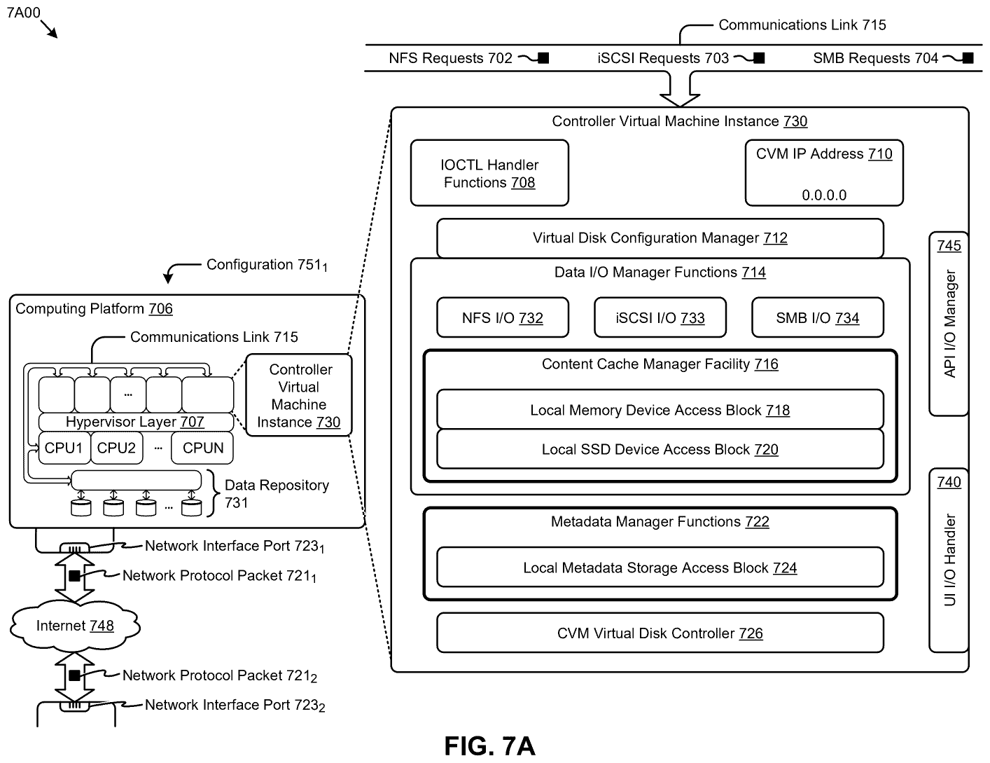

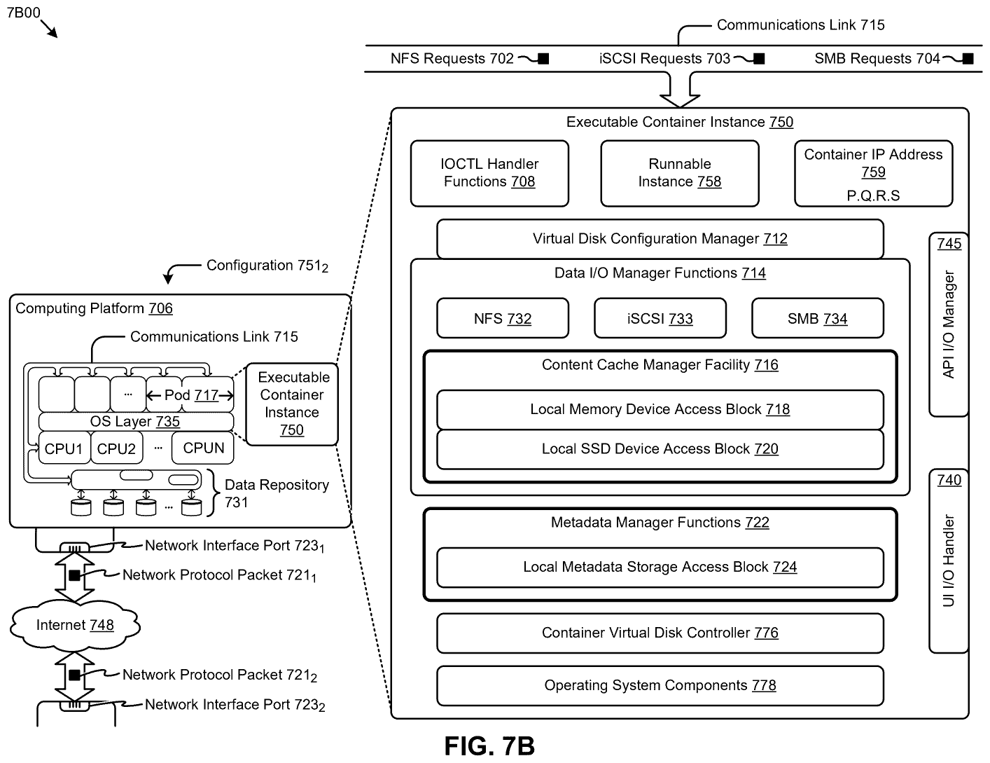

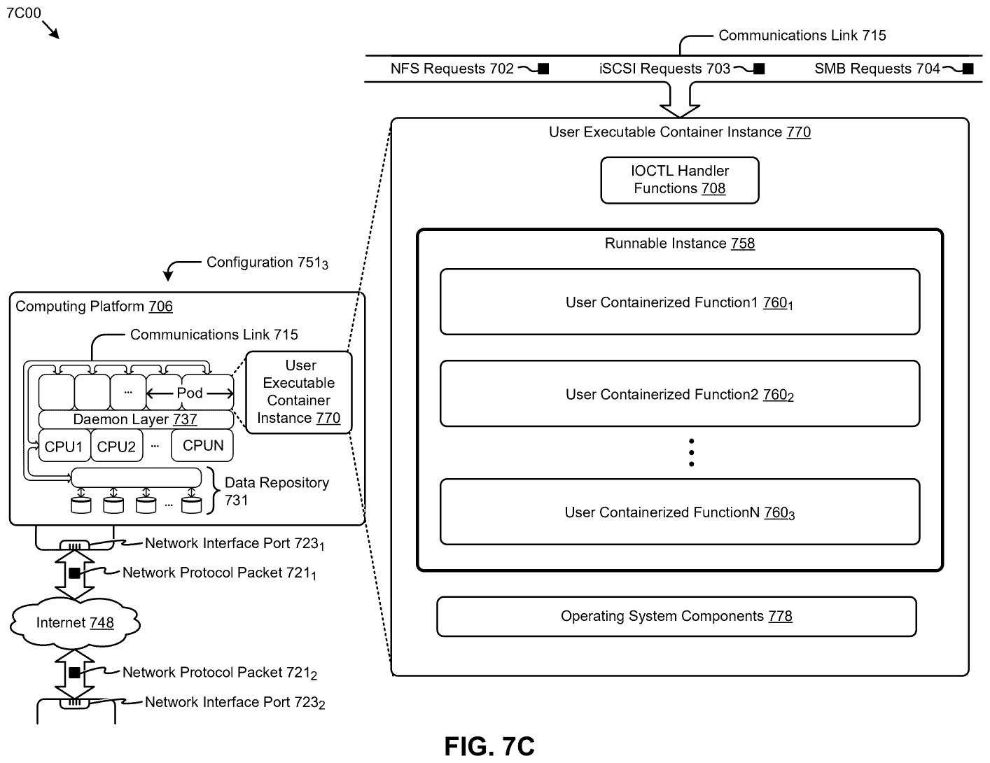

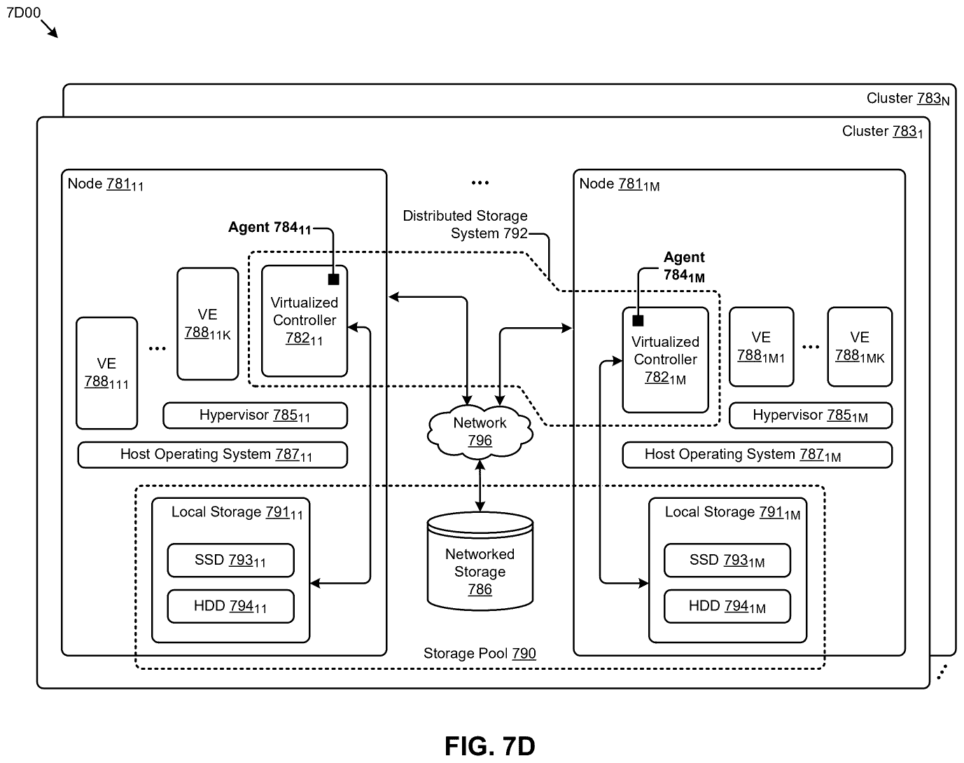

All or portions of any of the foregoing techniques can be partitioned into one or more modules and instanced within, or as, or in conjunction with, a virtualization system controller, also known herein as a virtualized controller. Some example instances of a virtualization system controller or virtualized controllers situated within various virtual computing environments are shown and discussed as pertains to FIG. 7A, FIG. 7B, FIG. 7C, and FIG. 7D.

FIG. 7A depicts a virtualized controller as implemented in the shown virtual machine architecture 7A00. The heretofore-disclosed embodiments, including variations of any virtualized controllers, can be implemented in distributed systems where a plurality of networked-connected devices communicate and coordinate actions using inter-component messaging.

As used in these embodiments, a virtualized controller is a collection of software instructions that serve to abstract details of underlying hardware or software components from one or more higher-level processing entities. A virtualized controller can be implemented as a virtual machine, as an executable container, or within a layer (e.g., such as hypervisor layer 707). Furthermore, as used in these embodiments, distributed systems are collections of interconnected components that are designed for, or dedicated to, storage operations as well as being designed for, or dedicated to, computing and/or networking operations.

Interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, computing and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system (OS) virtualization techniques are combined.

As shown, virtual machine architecture 7A00 comprises a collection of interconnected components suitable for implementing embodiments of the present disclosure and/or for use in the herein-described environments. Moreover, virtual machine architecture 7A00 includes a controller virtual machine instance 730 in configuration 751₁ that is further described below as pertaining to implementation of such a controller virtual machine instance 730. Configuration 751₁ supports virtual machine instances that are deployed as user virtual machines, or controller virtual machines or both. Such virtual machines interface with a hypervisor layer (as shown). Some virtual machines are configured to process storage inputs or outputs (I/O or IO) as received from any or every source within the computing platform. An example implementation of such a virtual machine that processes storage I/O is depicted as 730.

In this and other configurations, a controller virtual machine instance receives block I/O storage requests as network file system (NFS) requests in the form of NFS requests 702, and/or internet small computer system interface (iSCSI) block IO requests in the form of iSCSI requests 703, and/or Samba file system (SMB) requests in the form of SMB requests 704. The controller virtual machine (CVM) instance publishes and responds to an internet protocol (IP) address (e.g., CVM IP address 710). Various forms of input and output can be handled by one or more IO control (IOCTL) handler functions (e.g., IOCTL handler functions 708) that interface to other functions such as data IO manager functions 714 and/or metadata manager functions 722. As shown, the data IO manager functions can include communication with virtual disk configuration manager 712 and/or can include direct or indirect communication with any of various block IO functions (e.g., NFS 732, iSCSI 733, SMB 734, etc.).

In addition to block IO functions, configuration 751₁ supports input or output (IO) of any form (e.g., block IO, streaming IO) and/or packet-based IO such as hypertext transport protocol (HTTP) traffic, etc., through either or both of a user interface (UI) handler such as UI IO handler 740 and/or through any of a range of application programming interfaces (APIs), possibly through API IO manager 745.

Communications link 715 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, the detail of controller virtual machine instance 730 includes content cache manager facility 716 that accesses storage locations, possibly including local dynamic random access memory (DRAM) (e.g., through local memory device access block 718) and/or possibly including accesses to local solid state storage (e.g., through local SSD device access block 720).

Common forms of computer readable media include any non-transitory computer readable medium, for example, floppy disk, flexible disk, hard disk, magnetic tape, or any other magnetic medium; compact disk read-only memory (CD-ROM) or any other optical medium; punch cards, paper tape, or any other physical medium with patterns of holes; or any random access memory (RAM), programmable read-only memory (PROM), erasable programmable read-only memory (EPROM), flash memory EPROM (FLASH-EPROM), or any other memory chip or cartridge. Any data can be stored, for example, in any form of data repository 731, which in turn can be formatted into any one or more storage areas, and which can comprise parameterized storage accessible by a key (e.g., a filename, a table name, a block address, an offset address, etc.). Data repository 731 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 724. The data repository 731 can be configured using CVM virtual disk controller 726, which can in turn manage any number or any configuration of virtual disks.

Execution of a sequence of instructions to practice certain embodiments of the disclosure are performed by one or more instances of a software instruction processor, or a processing element such as a central processing unit (CPU) or data processor or graphics processing unit (GPU), or such as any type or instance of a processor (e.g., CPU1, CPU2, . . . , CPUN). According to certain embodiments of the disclosure, two or more instances of configuration 751₁ can be coupled by communications link 715 (e.g., backplane, local area network, public switched telephone network, wired or wireless network, etc.) and each instance may perform respective portions of sequences of instructions as may be required to practice embodiments of the disclosure.

The shown computing platform 706 is interconnected to the Internet 748 through one or more network interface ports (e.g., network interface port 723₁ and network interface port 723₂). Configuration 751₁ can be addressed through one or more network interface ports using an IP address. Any operational element within computing platform 706 can perform sending and receiving operations using any of a range of network protocols, possibly including network protocols that send and receive packets (e.g., network protocol packet 721₁ and network protocol packet 721₂).

Computing platform 706 may transmit and receive messages that can be composed of configuration data and/or any other forms of data and/or instructions organized into a data structure (e.g., communications packets). In some cases, the data structure includes program instructions (e.g., application code) communicated through the Internet 748 and/or through any one or more instances of communications link 715. Received program instructions may be processed and/or executed by a CPU as it is received and/or program instructions may be stored in any volatile or non-volatile storage for later execution. Program instructions can be transmitted via an upload (e.g., an upload from an access device over the Internet 748 to computing platform 706). Further, program instructions and/or the results of executing program instructions can be delivered to a particular user via a download (e.g., a download from computing platform 706 over the Internet 748 to an access device).

Configuration 751₁ is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (LAN) and/or through a virtual LAN (VLAN) and/or over a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

As used herein, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to implementing a heterogeneous storage tiering regime for high-performance failure recovery of a node of a computing cluster. In some embodiments, a module may include one or more state machines and/or combinational logic used to implement or facilitate the operational and/or performance characteristics pertaining to implementing a heterogeneous storage tiering regime for high-performance failure recovery of a node of a computing cluster.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of implementing a heterogeneous storage tiering regime for high-performance failure recovery of a node of a computing cluster). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to implementing a heterogeneous storage tiering regime for high-performance failure recovery of a node of a computing cluster, and/or for improving the way data is manipulated when performing computerized operations pertaining to implementing a heterogeneous storage tiering regime for high-performance failure recovery of a node of a computing cluster.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT” issued on Oct. 1, 2013, which is hereby incorporated by reference in its entirety.

FIG. 7B depicts a virtualized controller implemented by containerized architecture 7B00. The containerized architecture comprises a collection of interconnected components suitable for implementing embodiments of the present disclosure and/or for use in the herein-described environments. Moreover, the shown containerized architecture 7B00 includes an executable container instance 750 in configuration 751₂ that is further described below as pertaining to executable container instance 750. Configuration 751₂ includes an operating system layer (the shown OS layer 735) that performs addressing functions such as providing access to external requestors (e.g., user virtual machines or other processes) via an IP address 759 (e.g., “P.Q.R.S”, as shown). Providing access to external requestors can include implementing all or portions of a protocol specification, possibly including the hypertext transport protocol (HTTP or “http:”) and/or possibly handling port-specific functions. In this and other embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

An operating system layer (e.g., the shown OS layer 735) can perform port forwarding to any executable container (e.g., executable container instance 750). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a corresponding virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “Is”, “dir”, etc.). The executable container might optionally include operating system components 778, however such a separate set of operating system components need not be provided. As an alternative, an executable container can include runnable instance 758, which is built (e.g., through compilation and linking, or just-in-time compilation, etc.) to include any or all of any or all library entries and/or operating system (OS) functions, and/or OS-like functions as may be needed for execution of the runnable instance. In some cases, a runnable instance can be built with a virtual disk configuration manager, any of a variety of data IO management functions, etc. In some cases, a runnable instance includes code for, and access to, container virtual disk controller 776. Such a container virtual disk controller can perform any of the functions that the aforementioned CVM virtual disk controller 726 can perform, yet such a container virtual disk controller does not rely on a hypervisor or any particular host operating system so as to perform its range of functions.

In some environments, multiple executable containers can be collocated and/or can share one or more contexts. For example, multiple executable containers that share access to a virtual disk can be assembled into a pod 717 (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod). In various implementations a pod represents a set of running or runnable processes. A pod can be deployed as the lowest level executable unit of a containerized application. As used herein, a pod that is instanced within a node can be addressed by a local IP address.

FIG. 7C depicts a virtualized controller implemented by a daemon-assisted containerized architecture 7C00. The containerized architecture comprises a collection of interconnected components suitable for implementing embodiments of the present disclosure and/or for use in the herein-described environments. Moreover, the shown daemon-assisted containerized architecture includes a user executable container instance 770 in configuration 7513 that is further described below as pertaining to user executable container instance 770. Configuration 7513 includes a daemon layer 737 that performs certain functions of an operating system.

User executable container instance 770 comprises any number of user containerized functions (e.g., user containerized function1 760₁, user containerized function2 760₂, . . . , user containerized functionN 760₃). Such user containerized functions can execute autonomously or can be interfaced with or wrapped in a runnable object to create a runnable instance (e.g., runnable instance 758). In some cases, the shown operating system components 778 comprise portions of an operating system, which portions are interfaced with or included in the runnable instance and/or any user containerized functions. In this embodiment of a daemon-assisted containerized architecture, the computing platform 706 might or might not host operating system components other than operating system components 778. More specifically, the shown daemon might or might not host operating system components other than operating system components 778 of user executable container instance 770.

The virtual machine architecture 7A00 of FIG. 7A and/or the containerized architecture 7B00 of FIG. 7B and/or the daemon-assisted containerized architecture 7C00 of FIG. 7C can be used in any combination to implement a distributed platform that contains multiple servers and/or nodes that manage multiple tiers of storage where the tiers of storage might be formed using the shown data repository 731 and/or any forms of network accessible storage. As such, the multiple tiers of storage may include storage that is accessible over communications link 715. Such network accessible storage may include cloud storage or networked storage (NAS) and/or may include all or portions of a storage area network (SAN) and/or may include all or portions of a direct-attached storage fabric (DAS). Unlike prior approaches, the presently-discussed embodiments permit local storage that is within or directly attached (e.g., logically-attached) to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having an address space that is formed by a plurality of non-overlapping address range segments, possibly contiguous segments, respective ones of which non-overlapping address range segments correspond to (1) node-internal storage devices, or (2) any forms of network-accessible storage (e.g., cloud-provided storage).

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term “vDisk” refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor or corresponding computer modules that manages the interactions between the underlying hardware and user virtual machines or containers that run client software.

Distinct from user virtual machines or user executable containers, a special controller virtual machine or a special controller executable container can be used to manage certain storage and I/O activities. Such a special controller virtual machine is referred to as a “CVM”, or as a controller executable container, or as a service virtual machine (SVM), or as a service executable container, or as a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines-above the hypervisors-thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 7D depicts a distributed virtualization system in a multi-cluster environment 7D00. The shown distributed virtualization system is configured to be used to implement the herein disclosed techniques. Specifically, the distributed virtualization system of FIG. 7D comprises multiple clusters (e.g., cluster 783₁, . . . , cluster 783_{N}) comprising multiple nodes that have multiple tiers of storage in a storage pool. Representative nodes (e.g., node 781₁₁, . . . , node 781_{1M}) and storage pool 790 associated with cluster 783₁ are shown. Each node can be associated with one server, multiple servers, or portions of a server. The nodes can be associated (e.g., logically and/or physically) with the clusters. As shown, the multiple tiers of storage include storage that is accessible through a network 796, such as a networked storage 786 (e.g., a storage area network or SAN, network-attached storage or NAS, etc.). The multiple tiers of storage further include instances of local storage (e.g., local storage 791₁₁, . . . , local storage 791_{1M}). For example, the local storage can be within or directly attached to a server and/or appliance associated with the nodes. Such local storage can include solid state drives (SSD 793₁₁, . . . , SSD 793_{1M}), hard disk drives (HDD 794₁₁, . . . , HDD 794_{1M}), and/or other storage devices.

As shown, any of the nodes of the distributed virtualization system can implement one or more user virtualized entities (VEs) such as the virtualized entity (VE) instances shown as VE 788₁₁₁, . . . , VE 788_{11K}, . . . , VE 788_{1M1}, . . . , VE 788_{1MK}, and/or a distributed virtualization system can implement one or more virtualized entities that may be embodied as a virtual machines (VM) and/or as an executable container. The VEs can be characterized as software-based computing “machines” implemented in a container-based or hypervisor-assisted virtualization environment that emulates underlying hardware resources (e.g., CPU, memory, etc.) of the nodes. For example, multiple VMs can operate on one physical machine (e.g., node host computer) running a single host operating system (e.g., host operating system 787₁₁, . . . , host operating system 787_{1M}), while the VMs run multiple applications on various respective guest operating systems. Such flexibility can be facilitated at least in part by a hypervisor (e.g., hypervisor instance 785₁₁, . . . , hypervisor instance 785_{1M}), which hypervisor instances are logically located between the various guest operating systems of the VMs and the host operating system of the physical infrastructure (e.g., node).

As an alternative, executable containers may be implemented at the nodes in an operating system-based virtualization environment or in a containerized virtualization environment having an executable container implementation. In some cases, such an executable container is a node-local virtualized controller. Additionally or alternatively, a such an executable container is a containerized version of a node-local control virtual machine.

The executable containers comprise groups of processes and/or may use resources (e.g., memory, CPU, disk, etc.) that are isolated from the node host computer and other containers. Such executable containers directly interface with the kernel of the host operating system (e.g., host operating system 787₁₁, . . . , host operating system 787_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 790 by the VMs and/or the executable containers.

Multiple instances of such virtualized controllers can coordinate within a cluster to form the distributed storage system 792 which can, among other operations, manage the storage pool 790. This architecture further facilitates efficient scaling in multiple dimensions (e.g., in a dimension of computing power, in a dimension of storage space, in a dimension of network bandwidth, etc.).

A particularly-configured instance of a virtual machine at a given node can be used as a virtualized controller in a hypervisor-assisted virtualization environment to manage storage and I/O (input/output or IO) activities of any number or form of virtualized entities. For example, the virtualized entities at node 781₁₁ can interface with a controller virtual machine (e.g., virtualized controller 782₁₁) through hypervisor instance 785₁₁ to access data of storage pool 790. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 792. For example, a hypervisor at one node in the distributed storage system 792 might correspond to software from a first vendor, and a hypervisor at another node in the distributed storage system 792 might correspond to a second software vendor. As another virtualized controller implementation example, executable containers can be used to implement a virtualized controller (e.g., virtualized controller 782_{1M}) in an operating system virtualization environment at a given node. In this case, for example, the virtualized entities at node 781_{1M} can access the storage pool 790 by interfacing with a controller container (e.g., virtualized controller 782_{1M}) through hypervisor instance 785_{1M} and/or the kernel of host operating system 787_{1M}.

In certain embodiments, one or more instances of a computing agent can be implemented in the distributed storage system 792 to facilitate the herein disclosed techniques. Specifically, agent 784₁₁ can be implemented in the virtualized controller 782₁₁, and agent 784_{1M} can be implemented in the virtualized controller 782_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

Solutions attendant to implementing a heterogeneous storage tiering regime for high-performance failure recovery of a node of a computing cluster can be brought to bear through implementation of any one or more of the foregoing techniques. Moreover, any aspect or aspects of computing clusters need to be configured for high availability data replication yet without unduly consuming performance tier capacity can be implemented in the context of the foregoing environments.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A non-transitory computer readable medium having stored thereon a sequence of instructions which, when stored in memory and executed by a processor cause the processor to perform acts for using network accessible volumes in failure recovery operations, the acts comprising:
configuring a computing cluster having at least two nodes, the at least two nodes hosting virtualized entities that are configured to access a common storage access address space, and the at least two nodes having respective one or more node-local non-volatile storage devices, wherein the respective one or more node-local non-volatile storage devices are configured into a first storage tier that stores node-local data;
attaching additional cloud-provided storage to the at least two nodes having their respective one or more node-local non-volatile storage devices, wherein the additional cloud-provided storage is configured into a second storage tier that stores one or more replicas of the node-local data;
responding to a node failure event by:
attaching the additional cloud-provided storage to a replacement node; and
rebuilding, on the replacement node, rebuilt first storage tier data based on the one or more replicas of the node-local data that are stored in the second storage tier of the additional cloud-provided storage.

2. The non-transitory computer readable medium of claim 1, wherein the first storage tier comprises the one or more node-local non-volatile storage devices are node-local SSD/NVMe devices; and wherein the second storage tier or a third storage tier comprises cloud-provided network-attached storage.

3. The non-transitory computer readable medium of claim 2 wherein the first storage tier is a performance tier composed of the node-local SSD/NVMe devices and the second storage tier, or a third storage tier are composed of cloud-provided storage devices of the additional cloud-provided storage.

4. The non-transitory computer readable medium of claim 1, wherein at least some of the virtualized entities that are accessible by the at least two nodes via the common storage access address space are user virtual machines or user executable containers.

5. The non-transitory computer readable medium of claim 1, wherein at least some of the virtualized entities that are accessible by the at least two nodes via the common storage access address space are user executable containers that implement a node-local virtualized controller or a containerized version of a node-local control virtual machine.

6. The non-transitory computer readable medium of claim 1, further comprising instructions which, when stored in memory and executed by the processor cause the processor to perform further acts of formation of the rebuilt first storage tier data based on the one or more replicas of the node-local data that are stored in a non-replacement node of the computing cluster.

7. The non-transitory computer readable medium of claim 6, wherein the rebuilt first storage tier data includes rebuilding of a hot-tier index.

8. The non-transitory computer readable medium of claim 1, wherein the additional cloud-provided storage is accessed as at least one of, a network-attached storage (NAS) facility, a storage area network (SAN) facility, or a network-accessible direct-attached storage (DAS) facility.

9. A method for using network accessible volumes in failure recovery operations, the method comprising:
configuring a computing cluster having at least two nodes, the at least two nodes hosting virtualized entities that are configured to access a common storage access address space, and the at least two nodes having respective one or more node-local non-volatile storage devices, wherein the respective one or more node-local non-volatile storage devices are configured into a first storage tier that stores node-local data;
attaching additional cloud-provided storage to the at least two nodes having their respective one or more node-local non-volatile storage devices, wherein the additional cloud-provided storage is configured into a second storage tier that stores one or more replicas of the node-local data;
responding to a node failure event by:
attaching the additional cloud-provided storage to a replacement node; and
rebuilding, on the replacement node, rebuilt first storage tier data based on the one or more replicas of the node-local data that are stored in the second storage tier of the additional cloud-provided storage.

10. The method of claim 9, wherein the first storage tier comprises the one or more node-local non-volatile storage devices are node-local SSD/NVMe devices; and wherein the second storage tier or a third storage tier comprises cloud-provided network-attached storage.

11. The method of claim 10 wherein the first storage tier is a performance tier composed of the node-local SSD/NVMe devices and the second storage tier, or a third storage tier are composed of cloud-provided storage devices of the additional cloud-provided storage.

12. The method of claim 9, wherein at least some of the virtualized entities that are accessible by the at least two nodes via the common storage access address space are user virtual machines or user executable containers.

13. The method of claim 9, wherein at least some of the virtualized entities that are accessible by the at least two nodes via the common storage access address space are user executable containers that implement a node-local virtualized controller or a containerized version of a node-local control virtual machine.

14. The method of claim 9, further comprising formation of the rebuilt first storage tier data based on the one or more replicas of the node-local data that are stored in a non-replacement node of the computing cluster.

15. The method of claim 14, wherein the rebuilt first storage tier data includes rebuilding of a hot-tier index.

16. The method of claim 9, wherein the additional cloud-provided storage is accessed as at least one of, a network-attached storage (NAS) facility, a storage area network (SAN) facility, or a network-accessible direct-attached storage (DAS) facility.

17. A system for using network accessible volumes in failure recovery operations, the system comprising:
a storage medium having stored thereon a sequence of instructions; and
a processor that executes the sequence of instructions to cause the processor to perform acts comprising,
configuring a computing cluster having at least two nodes, the at least two nodes hosting virtualized entities that are configured to access a common storage access address space, and the at least two nodes having respective one or more node-local non-volatile storage devices, wherein the respective one or more node-local non-volatile storage devices are configured into a first storage tier that stores node-local data;
attaching additional cloud-provided storage to the at least two nodes having their respective one or more node-local non-volatile storage devices, wherein the additional cloud-provided storage is configured into a second storage tier that stores one or more replicas of the node-local data;
responding to a node failure event by:
attaching the additional cloud-provided storage to a replacement node; and
rebuilding, on the replacement node, rebuilt first storage tier data based on the one or more replicas of the node-local data that are stored in the second storage tier of the additional cloud-provided storage.

18. The system of claim 17, wherein the first storage tier comprises the one or more node-local non-volatile storage devices are node-local SSD/NVMe devices; and wherein the second storage tier or a third storage tier comprises cloud-provided network-attached storage.

19. The system of claim 18 wherein the first storage tier is a performance tier composed of the node-local SSD/NVMe devices and the second storage tier, or a third storage tier are composed of cloud-provided storage devices of the additional cloud-provided storage.

20. The system of claim 17, wherein at least some of the virtualized entities that are accessible by the at least two nodes via the common storage access address space are user virtual machines or user executable containers.

21. The system of claim 17, wherein at least some of the virtualized entities that are accessible by the at least two nodes via the common storage access address space are user executable containers that implement a node-local virtualized controller or a containerized version of a node-local control virtual machine.

22. The system of claim 17, further comprising instructions which, when stored in memory and executed by the processor cause the processor to perform further acts of formation of the rebuilt first storage tier data based on the one or more replicas of the node-local data that are stored in a non-replacement node of the computing cluster.

23. The system of claim 22, wherein the rebuilt first storage tier data includes rebuilding of a hot-tier index.

24. The system of claim 17, wherein the additional cloud-provided storage is accessed as at least one of, a network-attached storage (NAS) facility, a storage area network (SAN) facility, or a network-accessible direct-attached storage (DAS) facility.
